(19) United States
(12) Patent Application Publication
(10) Pub. No.: US 2025/0386182 A1
(43) Pub. Date: Dec. 18, 2025

(54) RADIO ACCESS NETWORK (RAN) USER EQUIPMENT (UE) IDENTIFIER PRIVACY

(71) Applicant: QUALCOMM Incorporated, San Diego, CA (US)

(72) Inventors: Hongil KIM, San Diego, CA (US); Soo Bum LEE, San Diego, CA (US); Gavin Bernard HORN, La Jolla, CA (US); Gabi SARKIS, San Diego, CA (US); Aziz GHOLMIEH, Del Mar, CA (US); Ozcan OZTURK, San Diego, CA (US)

(21) Appl. No.: 18/741,604

(22) Filed: Jun. 12, 2024

(51) Int. Cl. H04W 8/26; H04W 12/02; H04W 12/08

(52) U.S. Cl. CPC H04W 8/26; H04W 12/02; H04W 12/08

(57) ABSTRACT

Disclosed are systems and techniques for wireless communications. For instance, a process can include communicating with a network node based on first radio network temporary identifier (RNTI), determining to switch to a second RNTI, and communicating with the network node based on the second RNTI.

### FIELD

The present disclosure generally relates to wireless communications. For example, aspects of the present disclosure relate to systems and techniques for providing enhanced privacy for priority access in wireless systems such as wireless communication systems.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

Although wireless communication systems have made great technological advancements over many years, challenges still exist. For example, complex and dynamic environments can still attenuate or block signals between wireless transmitters and wireless receivers, undermining a throughput a wireless device is able to achieve to a particular wireless network, given the wireless nodes that can be used to access the wireless network. Consequently, an ability of a wireless device, such as user equipment (UE), to select from multiple wireless networks, such from among a 5G and another wireless network, or from among multiple 5G networks should be enhanced.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for performing wireless communications. In one illustrative example, an apparatus for wireless communications is provided that includes at least one memory and at least one processor (e.g., implemented in circuitry) coupled to the at least one memory. The at least one processor is configured to: communicate with a network node based on first radio network temporary identifier (RNTI); determine to switch to a second RNTI; and communicate with the network node based on the second RNTI.

As another example, a method for wireless communications is provided. The method includes: communicating with a network node based on first radio network temporary identifier (RNTI); determining to switch to a second RNTI; and communicating with the network node based on the second RNTI.

In another example, a non-transitory computer-readable medium having stored thereon instructions is provided. The instructions, when executed by at least one processor, cause the at least one processor to: communicate with a network node based on first radio network temporary identifier (RNTI); determine to switch to a second RNTI; and communicate with the network node based on the second RNTI.

As another example, an apparatus for wireless communications provided. The apparatus includes: means for communicating with a network node based on first radio network temporary identifier (RNTI); means for determining to switch to a second RNTI; and means for communicating with the network node based on the second RNTI.

In another example, an apparatus for wireless communications is provided that includes at least one memory and at least one processor (e.g., implemented in circuitry) coupled to the at least one memory. The at least one processor is configured to: communicate with a wireless device based on first radio network temporary identifier (RNTI); determine a second RNTI for the wireless device; and communicate with the wireless device based on the second RNTI.

As another example, a method for wireless communications is provided. The method includes: communicating with a wireless device based on first radio network temporary identifier (RNTI); determining a second RNTI for the wireless device; and communicating with the wireless device based on the second RNTI.

In another example, a non-transitory computer-readable medium having stored thereon instructions is provided. The instructions, when executed by at least one processor, cause the at least one processor to: communicate with a wireless device based on first radio network temporary identifier (RNTI); determine a second RNTI for the wireless device; and communicate with the wireless device based on the second RNTI.

As another example, an apparatus for wireless communications provided. The apparatus includes: means for communicating with a wireless device based on first radio network temporary identifier (RNTI); means for determining a second RNTI for the wireless device; and means for communicating with the wireless device based on the second RNTI.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIGS. 5A-5D depict various example aspects of data structures for a wireless communication network, in accordance with some examples;

FIG. 6 illustrates an example connection procedure to establish a connection with a wireless network, in accordance with aspects of the present disclosure;

FIG. 7 is a message diagram illustrating a technique for reallocating cell radio network temporary identifiers (C-RNTIs), in accordance with aspects of the present disclosure;

FIG. 8 is a message diagram illustrating a technique for reallocating C-RNTIs using radio resource control (RRC) messaging, in accordance with aspects of the present disclosure;

FIG. 9 is a message diagram illustrating a technique for reallocating C-RNTIs using physical random access channel (PRACH), in accordance with aspects of the present disclosure;

FIG. 10 is a flow diagram of a process for wireless communications, in accordance with aspects of the present disclosure;

FIG. 11 is a flow diagram of a process for wireless communications, in accordance with aspects of the present disclosure; and

FIG. 12 is a diagram illustrating an example of a computing system, according to aspects of the disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

In some cases, a wireless device, such as user equipment (UE), may establish certain connections, such as a radio resource control (RRC) connection, with a wireless network via random access channel (RACH) procedure. During this RACH procedure, the UE and the wireless network may exchange certain identifiers which may be used to identify the connection. One example of such an identifier may be a temporary cell radio network temporary identifier (C-RNTI). The temporary C-RNTI may be used to identify an RRC connection in a cell (e.g., base station, eNB, gNB, evolved distributed unit (CDU), AP, etc.). In some networks, a C-RNTI, as well as other RAN temporary identities (RNTIs), may be uniquely assigned to a UE and the C-RNTI may remain the same as long the UE is connected to a particular network node (e.g., base station, eNB, gNB, evolved distributed unit (CDU), etc.). As the C-RNTI can go unchanged for a relatively long period of time (e.g., when connected to a network node near home, work, etc.) there may be possible privacy concerns. In some cases, it may be useful to have a technique for reallocating RNTIs to provide RAN UE ID privacy.

Systems, apparatuses, electronic devices, methods (also referred to as processes), and computer-readable media (collectively referred to herein as “systems and techniques”) are described herein for providing Radio Access Network (RAN) UE identifier privacy in wireless systems. For example, the systems and techniques can provide RAN UE identifier privacy by reallocating a temporary identifier, such as a radio network temporary identifier (e.g., the C-RNTI). While examples are described herein using a C-RNTI as an example of a temporary identifier, the systems and techniques can be performed or used for any type of temporary identifier.

For example, a first C-RNTI may be initially established as a part of a connection procedure and a UE may communicate with a network node using the first C-RNTI. Sometime later, it may be useful to change (e.g., reallocate, switch, refresh, update, etc.) the C-RNTI to avoid attacks that may try to observe signals over a period of time. To reallocate the C-RNTI, the UE may receive an indication of a second C-RNTI and switch to the second C-RNTI based on an indication to change C-RNTIs. The UE may then use the second C-RNTI to continue communicating with the same network node.

In some cases, the UE may, as part of a capability exchange, send capability information indicating what messaging protocols the UE may support for C-RNTI reallocation. The network node may then reply with configuration information indicating which messaging protocol(s) to use for C-RNTI reallocation.

In some examples, the indication of the second C-RNTI may be provided via a radio resource control (RRC) message, a medium access control element (MAC CE) message, a physical random access channel (PRACH) procedure, or a preconfigured key (e.g., a shared key for deriving the second C-RNTI that may be shared during a configuration process for a UE for a wireless network/network node). In some cases, the second C-RNTI may be provided in a list and the list may include multiple C-RNTIs. In some examples, the indication to change C-RNTIs may indicate to the UE to use a next C-RNTI (e.g., the second C-RNTI) in the list. In some cases, the second C-RNTI may be derived using a preconfigured key and a key derivation formula (e.g., HMAC SHA-256, etc.). In some examples, the first C-RNTI may also be used to derive the second C-RNTI. In cases where the second C-RNTI may be derived, a length (e.g., number of bits) of the C-RNTI may be expanded from 16 bits. For example, the C-RNTI may be expanded to 17 bits or more (e.g., 32 bits, 64 bits, etc.) in length. With randomly generated C-RNTIs (e.g., based on a derived C-RNTI rather than assigned C-RNTI), as the number of active UEs in an area increase, a chance of a randomly generated RNTI colliding with a RNTI already in use increases (e.g., ˜7% chance for 100 active UEs, ˜99% with 800 or more active UEs, etc.). Increasing the size of the C-RNTI from 16 bits to 17 or more bits may decrease this chance of collisions. In some cases, to recover from a C-RNTI collision, a UE may perform a new PRACH procedure.

In some cases, the indication of the second C-RNTI may be sent in a MAC CE message, and the MAC CE message may also include the indication to change C-RNTIs. In some cases, the indication of the second C-RNTI may be received based on a PRACH procedure. In a PRACH procedure, the UE may be configured to set a PRACH inactivity timer based as received indication. In some cases, the PRACH inactivity timer may be a timer that is started when a PRACH occurs and that tracks an amount of time that has elapsed since a previous PRACH operation. A UE may perform a PRACH operation when the PRACH inactivity time expires/reaches a certain value. The second C-RNTI may be received by the UE during the PRACH procedure. In some examples, the indication of the second C-RNTI is sent based on an RRC message. In such cases, the indication to change the C-RNTI may be received as any of a DCI-based message, a MAC CE based message, another RRC message, based on a timer (e.g., periodicity, such as a timer set when the first C-RNTI is configured and upon the timer expiring/reaching a certain number, the first C-RNTI may be changed to the second C-RNTI), or based on a time (e.g., periodicity) for example, a number of transport blocks or packets transmitted associated with the first RNTI. In some cases, a time periodicity (e.g., timer, time) may be fixed (e.g., non-adjustable after configuration, such as in a standard, at development time, during production, etc.).

Additional aspects of the present disclosure are described in more detail below.

Wireless networks are deployed to provide various communication services, such as voice, video, packet data, messaging, broadcast, and the like. A wireless network may support both access links for communication between wireless devices. An access link may refer to any communication link between a client device (e.g., a user equipment (UE), a station (STA), or other client device) and a base station (e.g., a 3GPP gNodeB (gNB) for 5G/NR, a 3GPP eNodeB (eNB) for LTE, a Wi-Fi access point (AP), or other base station) or a component of a disaggregated base station (e.g., a central unit, a distributed unit, and/or a radio unit). In one example, an access link between a UE and a 3GPP gNB may be over a Uu interface. In some cases, an access link may support uplink signaling, downlink signaling, connection procedures, etc.

In some aspects, wireless communications networks may be implemented using one or more modulation schemes. For example, a wireless communication network may be implemented using a quadrature amplitude modulation (QAM) scheme such as 16QAM, 32QAM, 64QAM, etc.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

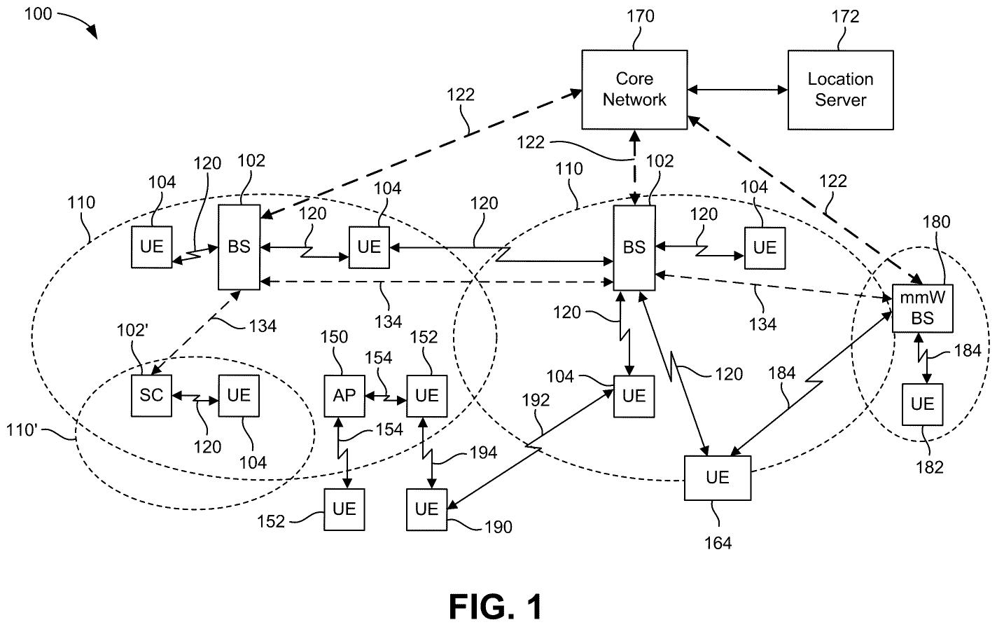

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (cMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHZ), FR3 (above 52600 MHZ), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHZ) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHZ aggregated carriers in a multi-carrier system would theoretically lead to a two-fold increase in data rate (i.e., 40 MHZ), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tuneable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

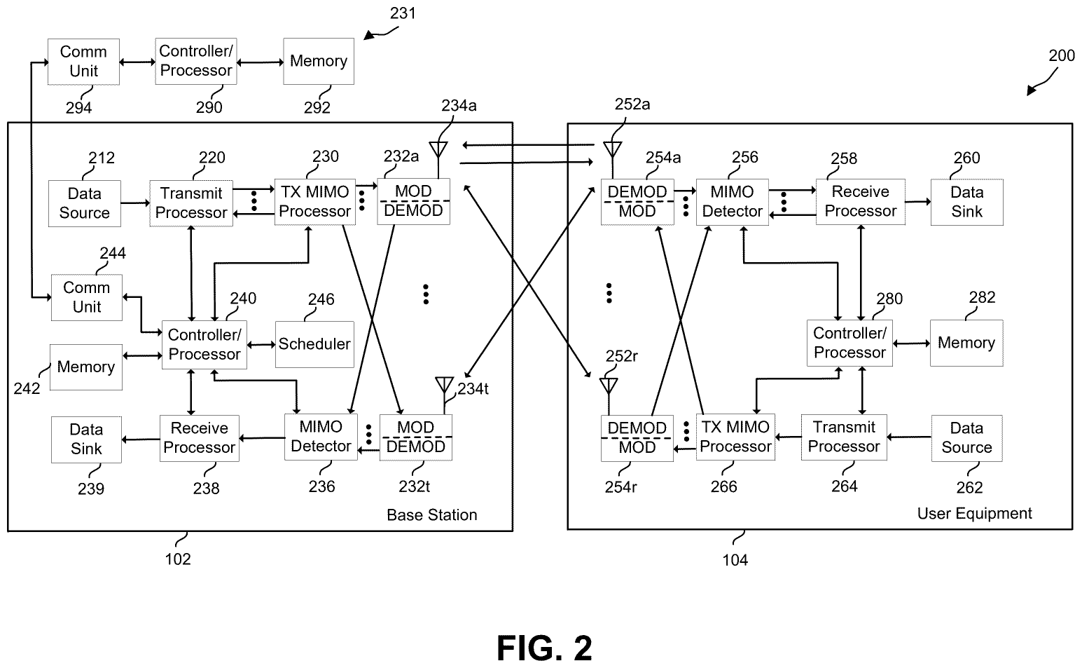

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

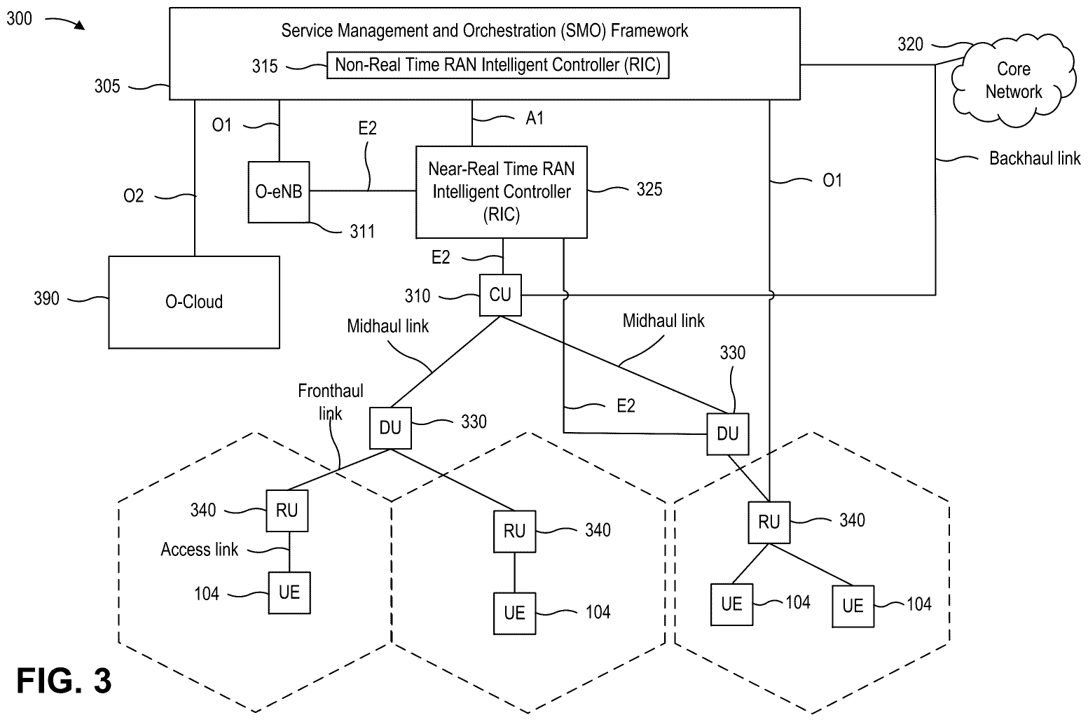

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUS 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

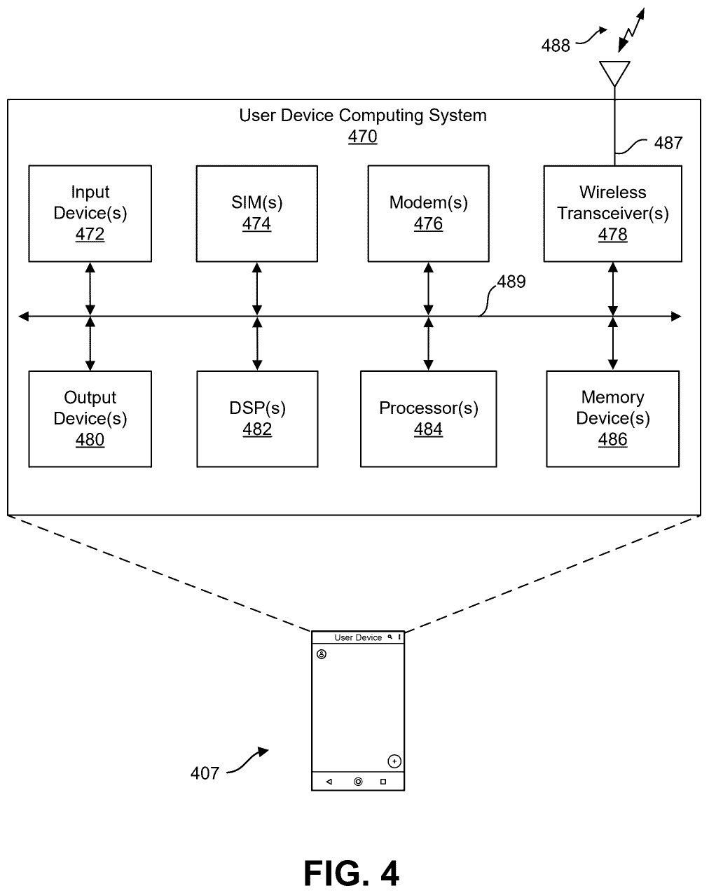

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR) or mixed reality (MR) device, etc.), Internet of Things (IoT) device, access point, and/or another device that is configured to communicate over a wireless communications network. The computing system 470 includes software and hardware components that may be electrically or communicatively coupled via a bus 489 (or may otherwise be in communication, as appropriate). For example, the computing system 470 includes one or more processors 484. The one or more processors 484 may include one or more CPUs, ASICs, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more subscriber identity modules (SIMs) 474, one or more modems 476, one or more wireless transceivers 478, one or more antennas 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various embodiments, and/or may be designed to implement methods and/or configure systems, as described herein.

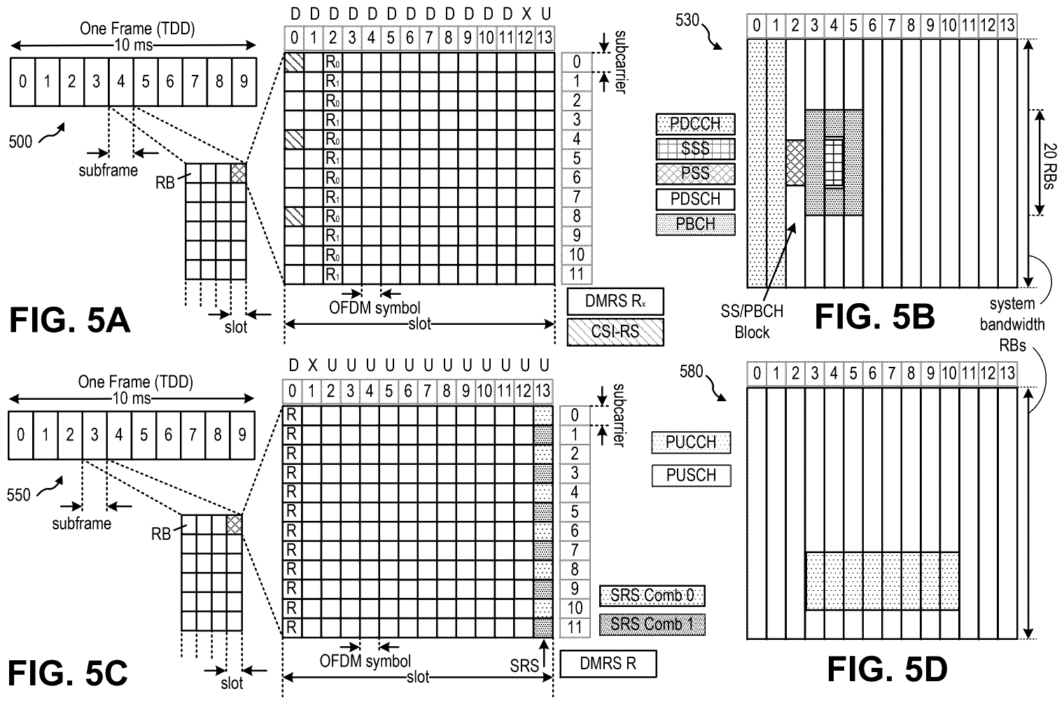

FIGS. 5A-5D depict various example aspects of data structures for a wireless communication system, such as wireless communication system 100 of FIG. 1. FIGS. 5A-5D depict aspects of data structures for a wireless communication network, such as wireless communication network 100 of FIG. 1. In particular, FIG. 5A is a diagram 500 illustrating an example of a first subframe within a 5G (e.g., 5G NR) frame structure, FIG. 5B is a diagram 530 illustrating an example of DL channels within a 5G subframe, FIG. 5C is a diagram 550 illustrating an example of a second subframe within a 5G frame structure, and FIG. 5D is a diagram 580 illustrating an example of UL channels within a 5G subframe.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 5A and 5C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2u slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 5A-5D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 5A, some of the REs carry reference (pilot) signals (RS) for a UE (e.g., UE 104, UE 152, UE 190). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 5B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., UE 104, UE 152, UE 190) to determine subframe/symbol timing and a physical layer identity. A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 5C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 5D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In some cases, a UE may not be connected from a wireless network (e.g., when there is no non-access stratum (NAS) signaling connection between the UE and the wireless network). For example, a UE may just have been powered up, the UE may exit from an airplane mode, the UE enters a new service area, RRC reconfiguration, handover, and the like. This disconnected UE may be in an idle state and the UE may listen for wireless networks. After the UE identifies a wireless network, the UE may then attempt to connect to the wireless network. In some cases, the UE may attempt to connect to the wireless network via a wireless node (e.g., network node) to establish an RRC connection.

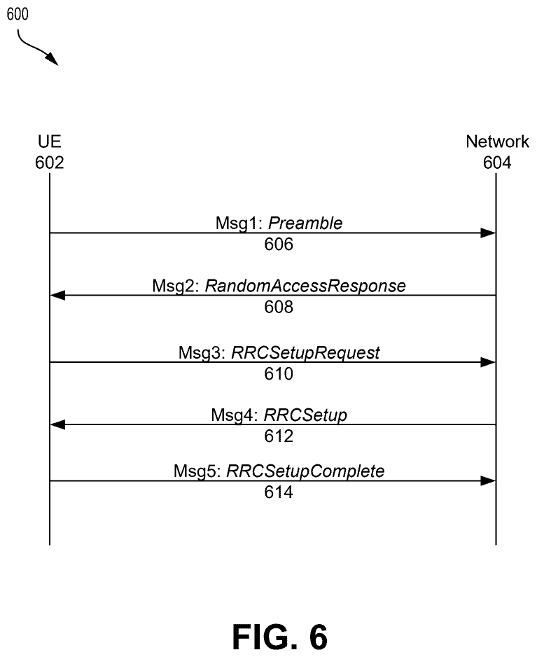

FIG. 6 illustrates an example connection procedure 600 to establish a connection with a wireless network, in accordance with aspects of the present disclosure. Connection procedure 600 includes messages exchanged between a UE 602 and network 604 (e.g., via a wireless node). In some cases, the connection procedure 600 may be a RACH procedure. In some cases, a msg1 606 maybe transmitted from the UE 602 to the network 604. The msg1 606 may include a preamble from the UE 602 to access the network 604. In response to the msg1 606, the network 604 may transmit a msg2 608 to the UE 602. In some cases, the msg2 608 may include initial information for connecting to the wireless node, such as timing alignment information, an initial uplink grant, and identifiers. The identifiers may include a preamble identifier, and a temporary cell radio network temporary identifier (C-RNTI). The temporary C-RNTI may be used to identify an RRC connection in a cell. In response to the msg2 608, the UE 602 may transmit a msg3 610 to the network 604. The msg3 610 may be transmitted based on the initial uplink grant from msg2 608 and the msg3 610 may include an RRC message. The RRC message may be a request to set up an RRC connection. For example, msg3 610 may include an RRCSetupRequest message.

The RRCSetupRequest may include an initial UE identifier(s) along with an establishment cause. In some cases, this initial UE identifier may include a portion of a temporary mobile subscriber identify (TMSI), and/or a 5G NR global unique identifier (5G-GUTI) and the C-RNTI. In some cases, the 5G-GUTI may be assigned to the UE 602 by the network 604 when the UE 602 registers with the network 604. In some cases, the TMSI may be derived based on the 5G-GUTI. The TMSI and/or the 5G-GUTI may be a core network identifier and may be maintained even if the RRC connection is lost. If the RRC setup is successful, msg4 612 may be sent from the network 604 to the UE 602 to establish the RRC connection. In response to msg4 612, the UE 602 may transmit msg5 614. Msg5 614 may be a RRCSetupComplete message and the RRCSetupComplete may include the C-RNTI.

In some networks, a C-RNTI, as well as other RAN temporary identities (RNTIs), may be uniquely assigned to a UE and the C-RNTI may remain the same as long the UE is connected to a particular network node (e.g., base station, cNG, gNB, AP, etc.). As the C-RNTI can go unchanged for a relatively long period of time (e.g., when connected to a network node near home, work, etc.) there may be possible privacy concerns. For example, a long-lasting C-RNTI for a UE may leak side-channel information (e.g., type of UE, services that UE is receiving, etc.) for the UE to passive cavesdroppers performing traffic analysis. Additionally, it may be possible to target an attack on/track a specific UE by linking a target UE's C-RNTI to the specific UE (e.g., personal identity of a user of the specific UE) via traffic analysis over time. In some cases, it may be useful to have a technique for reallocating RNTIs to provide RAN UE ID privacy.

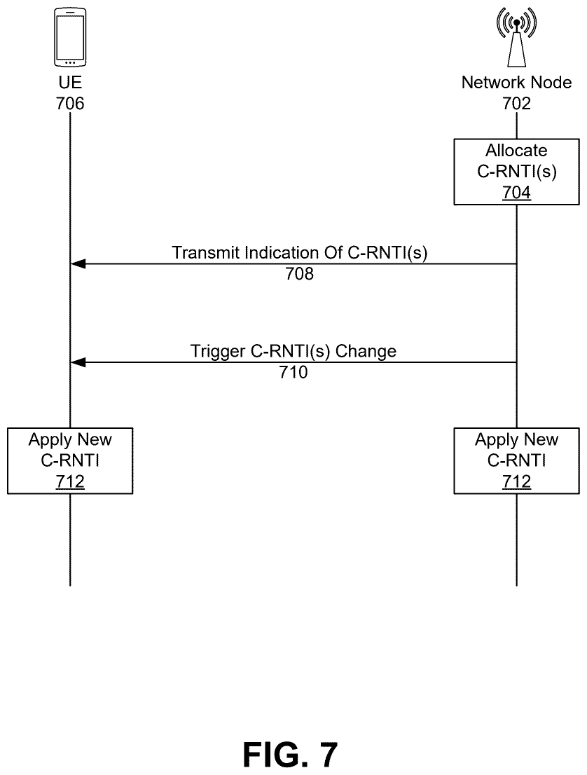

FIG. 7 is a message diagram illustrating a technique for reallocating C-RNTIs 700, in accordance with aspects of the present disclosure. In some cases, a C-RNTI may be reallocated using a two stage C-RNTI reallocation process. As shown in FIG. 7, the network node 702 may allocate one or more C-RNTIs 704 to the UE 706 connecting to the network node 702. After allocation, the network node 702 may transmit 708 an indication of the one or more allocated C-RNTIs to the UE 706. The network node 702 may transmit 708 the indication of the one or more allocated C-RNTIs as a part of setting up a connection with the UE 706 after security activation. The indication of the one or more C-RNTIs may be transmitted 708 via different messaging protocols, such as any of an RRC reconfiguration message, a medium access control control element (MAC CE), or a physical random access channel (PRACH) procedure. In some cases, the indication of the one or more C-RNTIs may include multiple C-RNTIs for the network node 702 (e.g., for that single network node/base station/cell). For example, the network node 702 may transmit an RRC reconfiguration message with a list of multiple C-RNTIs to the UE 706. Including multiple C-RNTIs may help reduce signaling overhead and/or processing delays.

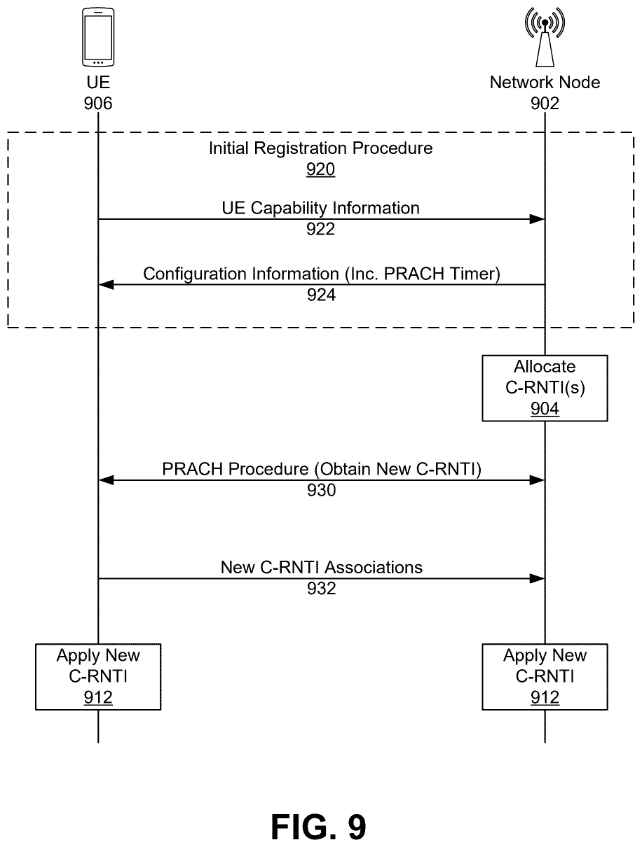

In some cases, the indication of the one or more C-RNTIs may be dynamically determined based on a key, an indication of a pre-shared key, information that may be applied to a pre-shared key (e.g., nonce value, parameters, etc.), and the like. The UE 706 may generate a new C-RNTI based on the indication. For example, the UE 706 may be preconfigured (e.g., during a configuration process of the UE 706 for the network node 702) with a key for generating a C-RNTI. As a more detailed example, the network node 702 may derive a key KRNTI from a key (KgxB) of the network node 702. The key KRNTI may be provided to the network node 702, as the pre-shared key. Both the UE 706 and the network node 702 may derive an initial C-RNTI based on the pre-shared key KRNTI such that KRNTI=KDF (KgNB, params), where KDF represents a predetermined (e.g., via a specification) key derivation formula, and params includes one or more parameters such as cell specific parameters (e.g., physical cell identifier (PCI)), freshness parameters, etc. For reallocating the C-RNTI, the UE 706 and network node 702 may derive a next C-RNTI (e.g., new C-RNTI) based on the pre-shared key KRNTI such that C-RNTINext=KDF (KRNTI, C-RNTICurrent), where C-RNTICurrent is the C-RNTI currently in use. In some cases, a next C-RNTI may collide with a C-RNTI already in use by another device. In cases where a collision occurs, the network node 702 may detect such a collision and send an indication to the UE to use another next C-RNTI (e.g., next C-RNTI in sequence) using any of a RRC reconfiguration procedure, MAC CE message, or DCI message. In some cases, to recover from the collision, the UE may perform a PRACH procedure (e.g., as discussed with respect to FIG. 9). In some cases, the C-RNTI may be expanded from 16-bits to 32-bits or more to reduce a probability of C-RNTI collisions.

After the indication of the one or more C-RNTIs are transmitted 708 to the UE 706, a change of the C-RNTI may be triggered 710 (e.g., based on an indication to change) and the UE 706 and network node 702 may both apply (e.g., use) a new C-RNTI 712 (e.g., use an indicated C-RNTI/a next C-RNTI in a list of C-RNTIs/a newly generated C-RNTI). In some cases, the change of the C-RNTI by the UE 706 may be triggered by a message (e.g., indication to change C-RNTI, trigger message, etc.) sent by the network node 702. This trigger message may be a RRC based trigger, a MAC CE-based trigger, or a DCI-based trigger. The trigger message may be transmitted via different messaging protocol as compared to the indication of the one or more C-RNTIs. For example, a network node may use any of an RRC-based allocation and DCI-based trigger, an RRC-based allocation and MAC CE-based trigger, an RRC-based allocation and timer-based trigger, a MAC CE-based allocation and immediate trigger, automatic generation (e.g., based on a preconfigured key) and timer-based indication, a PRACH-based allocation and immediate trigger, etc.

In other cases, the change of the C-RNTI may be timer based. For example, the UE 706 may be configured with a timer by the network node 702, for example, as a part of connecting with the network node 702. The UE 706 and network node 702 may then change the C-RNTI based on the configured timer (e.g., on expiration of the timer). In some cases, the UE 706 may start a timer in a DL slot n right after successfully changing the C-RNTI. The UE may be able to receive PDCCH/PDSCH messages or transmit PUSCH messages on the next DL or UL slot after the timer expires.

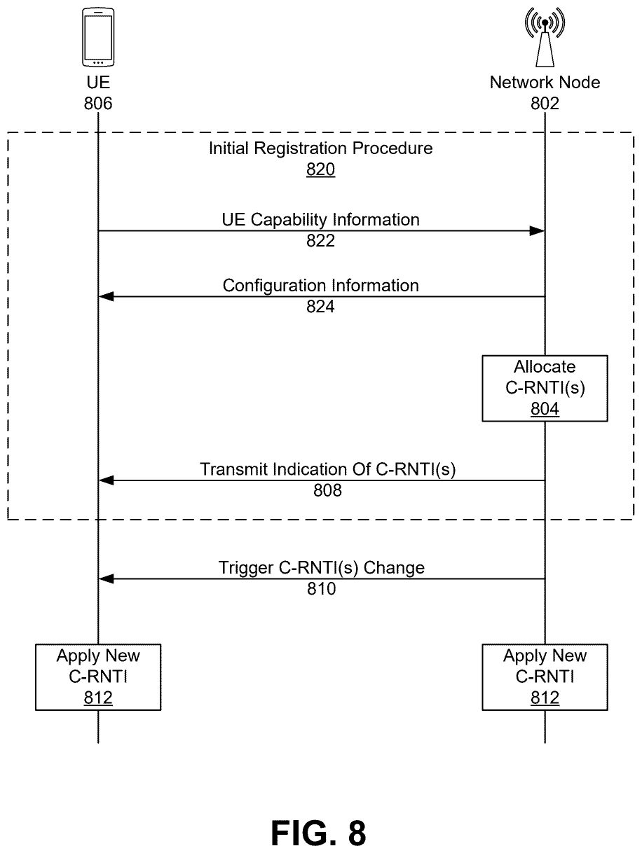

As indicated above, C-RNTI reallocation may be performed using different messaging protocols, such as RRC messages, MAC CE, or a PRACH procedure. FIG. 8 is a message diagram illustrating a technique for reallocating C-RNTIs using RRC messaging 800, in accordance with aspects of the present disclosure. FIG. 8 includes a network node 802 and UE 806, which may be substantially similar to a network node 702 and UE 706, respectively, of FIG. 7. In some cases, a network node 802 and UE 806 may perform an initial registration 820 procedure (e.g., as discussed in part with respect to FIG. 6) to connect the UE 806 to the network node 802. While discussed in the context of the initial registration 820 procedure, the techniques discussed herein may also apply to other techniques for connecting to a network node 802, such as for intra-cell handover. Thus, for RRC-based reallocation, the network node 802 may allocate new C-RNTI(s) during initial registration 820 with the network node 802, or during intra-cell handover (e.g., as a part of RRC reconfiguration). In some cases, the UE capability exchange may be performed after security activation and may be protected by the security procedures.

In some cases, during an initial registration 820 of the UE 806, such as a part of RRC setup, the UE 806 and network node 802 (or another network node) may perform a capability exchange where the UE 706 provides UE capability information 822 to the network node 802 and wireless network. In the UE capability information 822, the UE 806 may indicate which messaging protocol(s) the UE 806 supports and/or whether the UE 806 supports receiving multiple C-RNTIs for C-RNTI reallocation. Based on the UE capability information 822, the network node 802 may select which messaging protocols may be used for reallocation (e.g., messaging protocol for providing the C-RNTI(s) and messaging protocol for triggering a C-RNTI change). The network node 802 may provide configuration information 824 indicating to the UE 806 the messaging protocol(s) to use for reallocation. For example, the configuration information 824 may indicate how the UE 806 may determine a next C-RNTI (e.g., via a list of C-RNTIs, based on a preconfigured key, based on a new PRACH, etc.) and the configuration information 824 may indicate how the C-RNTI change may be triggered (e.g., via a RRC message, MAC CE message, PRACH, timer, etc.). The C-RNTI(s) may then be allocated 804 by the network node 802 and an indication of the C-RNTI(s) may be transmitted 808 to the UE 806 as a part of the initial registration 820. After the initial registration 820, a C-RNTI change may be triggered 810 and new C-RNTIs applied 812.

For MAC CE-based reallocation messaging, a network node (e.g., network node 702 of FIG. 7) may allocate a new C-RNTI to the UE (e.g., UE 706 of FIG. 7) at any time after establishing a secure connection (e.g., as a part of the initial registration procedure, or after the initial registration procedure is complete). In some cases, a network node may allocate a new C-RNTI to the UE and transmit a single MAC CE message including the new C-RNTI and an indication (e.g., trigger) to change the C-RNTI to the new C-RNTI.

FIG. 9 is a message diagram illustrating a technique for reallocating C-RNTIs using PRACH 900, in accordance with aspects of the present disclosure. For PRACH based reallocation, a UE 906 may perform a PRACH procedure to obtain a new RNTI. As shown in FIG. 9, a network node 902 and the UE 906 may perform an initial registration procedure 920 (e.g., as discussed in part with respect to FIG. 6) to connect the UE 806 to the network node 902. The initial registration procedure 920 may include a UE capability exchange where the UE 806 provides UE capability information 922 to the network node 902 and receives configuration information 924 indicating to the UE 906 to use PRACH for reallocation. In some cases, the UE capability exchange may be performed as a part of RRC reconfiguration. The configuration information 924 may configure a PRACH inactivity timer on the UE 906. Based on the PRACH inactivity timer (e.g., trigger for C-RNTI reallocation on expiration of the PRACH inactivity timer), the UE 906 may perform a PRACH procedure 930 to obtain a new C-RNTI. In some cases, the PRACH procedure 930 may be performed by transmitting, by the UE 906, a msg1 to the network node 902 via the PRACH channel, receiving a msg2 from the network node 902 including a new C-RNTI, in a manner similar to that described above with respect to FIG. 6. After the PRACH procedure, the UE 906 may inform (e.g., confirm reception by transmitting a message using the new C-RNTI) the network node 902 of the new C-RNTI association 932 via an existing RRC connection or an uplink MAC CE. The UE 906 and network node 902 may then apply the new C-RNTI 912 to use for further communications.

As indicated above, after the indication of the one or more C-RNTIs are transmitted, a change of the C-RNTI may be triggered and the UE and network node may both apply (e.g., use) a new C-RNTI. In some cases, the change of the C-RNTI may be triggered using an RRC-based indication. In some cases, a network node may allocate a new C-RNTI to a UE and send an indication to the UE to change the C-RNTI immediately (or anytime) after the allocation. In some cases, the UE may apply the new C-RNTI within a time T_{C-RNTIchangeRRC} upon receiving the change indication at the DL slot n. This time may be

$${T}_{C - RNTIchangeRRC} = \frac{{T}_{RRCprocessingDelay} ( 15 ms ) + {T}_{C - RNTIchangeDelayRRC} ( e . g . , 6 ms )}{NR Slot length}$$

slots after receiving the change indication.

In some cases, the change of the C-RNTI may be triggered using a MAC CE based indication. In some cases, a network node may allocate a new C-RNTI to a UE and send an indication to the UE to change the C-RNTI immediately (or anytime) after the allocation. In some cases, the UE may apply a new C-RNTI within a time T_{C-RNTIchangeDelayMACCE}+T_{HARQ} upon receiving the change indication at the DL slot n, where T_{C-RNTIchangeDelayMACCE} is the processing time for applying new C-RNTI, and T_{HARQ} is the timing between DL data transmission and acknowledgement.

In some cases, the change of the C-RNTI may be triggered using a DCI based indication. In some cases, the DCI based trigger indication may be a 1-bit change indication that is encoded in a DCI message. After being received by the UE in a downlink slot n, the UE may be able to apply the new C-RNTI for the next DL or UP slot. The UE may transmit a 1-bit change success indication in a UCI with the new C-RNTI being used in a next slot. In some cases, if the network node does not receive the success indication in the UCI, the network node may continue to use the previous C-RNTI.

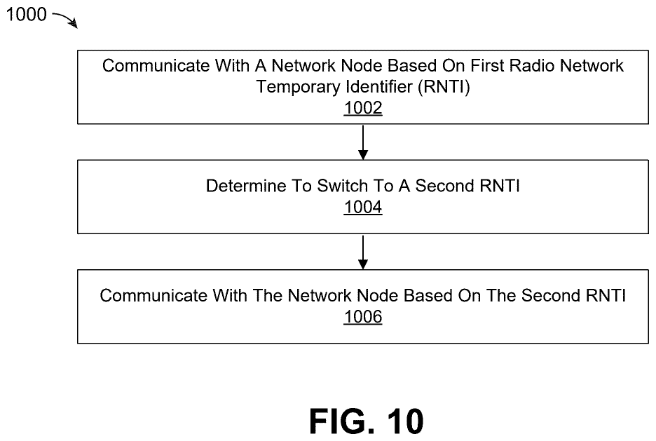

FIG. 10 is a flow diagram of a process 1000 for wireless communications, in accordance with aspects of the present disclosure. The process 1000 may be performed by a computing device (or apparatus) or a component (e.g., a chipset, codec, etc.) of the computing device. The computing device may be a mobile device (e.g., a mobile phone, UEs 104, 190, 152, 164, and 182 of FIG. 1, UE 104 of FIGS. 2-3, wireless device 407 of FIG. 4, UE 706 of FIG. 7, UE 806 of FIG. 8, UE 906 of FIG. 9, etc.), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., controller/processor 280 of FIG. 2, processor 484 of FIG. 4, processor 810 of FIG. 8, etc.).

At block 1002, the computing device (or component thereof) may communicate with a network node (e.g., base station 102, AP 150, mmW base station 180 of FIG. 1, DU 330 of FIG. 3, network node 702 of FIG. 7, network node 802 of FIG. 8, network node 902 of FIG. 9, etc.) based on first radio network temporary identifier (RNTI). In some cases, the RNTI may be a cell radio network temporary identifier (C-RNTI).

At block 1004, the computing device (or component thereof) may determine to switch to a second RNTI. In some cases, the second RNTI is based on a list of multiple RNTIs. In some examples, the computing device (or component thereof) may switch to the second RNTI based on a trigger to change RNTIs, wherein the trigger to change RNTIs triggers a change to a next RNTI on the list of multiple RNTIs. In some examples, the computing device (or component thereof) may transmit capability information indicating how the apparatus supports receiving a trigger to change to the second RNTI.

In some cases, the computing device (or component thereof) may receive, from the network node after security activation of a registration procedure: an indication to dynamically determine the second RNTI, and an indication of a trigger to change to the second RNTI. In some examples, the second RNTI is determined based on a message and the computing device (or component thereof) may receive the message from the network node; and determine the second RNTI based on the message received from the network node. In some cases, the message received from the network node comprises one of a Radio Resource Control (RRC) message or a Medium Access Control Control Element (MAC CE) message. In some examples, the message is received during one of an initial registration with the network node or intra-cell handover to the network node. In some cases, the message is received after security establishment in an Access Stratum (AS) layer. In some examples, the second RNTI is determined based on a preconfigured key and a key derivation formula. In some cases, the preconfigured key is determined based on at least a key of the network node and a freshness parameter. In some examples, the preconfigured key is further determined based on a physical cell identity. In some cases, the second RNTI is further derived based on the first RNTI. In some examples, the first RNTI and second RNTI are more than 16 bits long (e.g., 32 bits long). In some cases, the second RNTI is determined based on a PRACH procedure, and the computing device (or component thereof) may perform the PRACH procedure based on a PRACH inactivity timer, and wherein the indication to change RNTIs comprises receiving the second RNTI during the PRACH procedure. In some examples, the computing device (or component thereof) may switch to the second RNTI by transmitting an indication of the second RNTI using one of an existing RRC connection or an uplink MAC CE. In some cases, the computing device (or component thereof) may switch to the second RNTI based on a trigger to change RNTIs, wherein the trigger to change to the second RNTI is based on one of: a DCI-based message; a MAC CE based message; another RRC message; a timer; a number of packets transmitted with the first RNTI; and a number of transport blocks transmitted with the first RNTI. In some examples, the trigger to change to the second RNTI is encoded in downlink control information (DCI), wherein a change success indication is transmitted in an uplink control information (UCI) with the second RNTI, and wherein the change success indication indicates, to the computing device (or component thereof), that the RNTI has been changed successfully. In some cases, the trigger to change to the second RNTI comprises the timer and wherein the timer is one of a preconfigured timer or a fixed time periodicity. In some examples, the timer is based on one of a system frame number (SFN), subframe number, or slot number. In some cases, the trigger to change to the second RNTI is received using a MAC CE based message, and wherein the switch to the second RNTI is performed when sending an acknowledgement of the trigger to change to the second RNTI.

At block 1006, the computing device (or component thereof) may communicate with the network node based on the second RNTI.

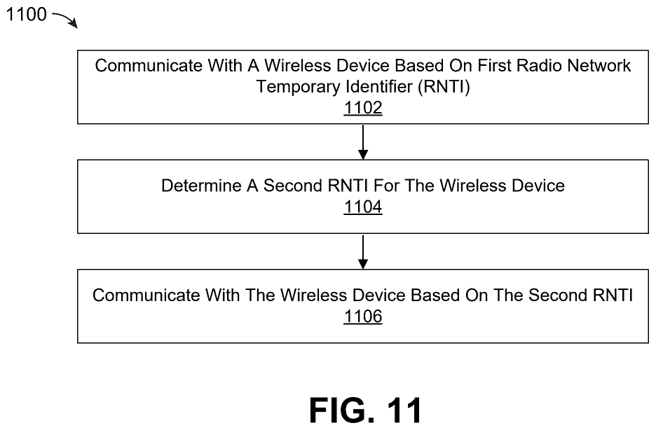

FIG. 11 is a flow diagram of a process 1100 for wireless communications, in accordance with aspects of the present disclosure. The process 1100 may be performed by a computing device (or apparatus) or a component (e.g., a chipset, codec, etc.) of the computing device. The computing device may be a network node/entity/device (e.g., base station 102, AP 150, mmW base station 180 of FIG. 1, DU 330 of FIG. 3, network node 702 of FIG. 7, network node 802 of FIG. 8, network node 902 of FIG. 9, etc.), network device, or other type of computing device. The operations of the process 1100 may be implemented as software components that are executed and run on one or more processors.

At block 1102, the computing device (or component thereof) may communicate with a wireless device based on first radio network temporary identifier (RNTI).

At block 1104, the computing device (or component thereof) may determine a second RNTI for the wireless device. In some cases, the second RNTI is based on a list of multiple RNTIs. In some examples, the computing device (or component thereof) may generate a trigger to change RNTIs based on the determination to send the second RNTI, wherein the trigger to change RNTIs triggers a change to a next RNTI on the list of multiple RNTIs; transmit the trigger to change RNTIs to the wireless device; and switch to the second RNTI based on the transmitted trigger to change RNTIs. In some cases, the computing device (or component thereof) may receive capability information indicating how the wireless device supports receiving the trigger to change RNTIs.

In some cases, the computing device (or component thereof) may determine to dynamically determine the second RNTI; and transmit an indication to dynamically determine the second RNTI to the wireless device. In some examples, a trigger to change RNTIs causes the wireless device to determine the second RNTI. In some cases, the trigger to change RNTIs is transmitted using one of a Radio Resource Control (RRC) message or a Medium Access Control Control Element (MAC CE) message. In some examples, the indication of how to determine the second RNTI is transmitted using one of a Radio Resource Control (RRC) message or a Medium Access Control Control Element (MAC CE) message. In some cases, the indication of how to determine the second RNTI is transmitted during one of an initial registration with the apparatus or intra-cell handover to the apparatus. In some examples, the indication of how to determine the second RNTI is transmitted after security establishment in an Access Stratum (AS) layer. In some cases, the computing device (or component thereof) may dynamically determine the second RNTI based on a preconfigured key and a key derivation formula. In some examples, the preconfigured key is determined based on at least a key of the apparatus and a freshness parameter. In some cases, the preconfigured key is further determined based on a physical cell identity. In some cases, the second RNTI is further derived based on the first RNTI. In some examples, the first RNTI and second RNTI are more than 16 bits long (e.g., 32 bits long). In some cases, the second RNTI is determined based on a PRACH procedure, and the computing device (or component thereof) may perform the PRACH procedure based on a PRACH inactivity timer, and wherein the indication to change RNTIs comprises transmitting the second RNTI during the PRACH procedure. In some examples, the computing device (or component thereof) may switch to the second RNTI by receiving an indication of the second RNTI using one of an existing RRC connection or an uplink MAC CE. In some cases, the computing device (or component thereof) may transmit the trigger to change RNTIs using one of: a DCI-based message; a MAC CE based message; another RRC message; a timer; a number of packets transmitted with the first RNTI; and a number of transport blocks transmitted with the first RNTI. In some examples, the trigger to change RNTIs is encoded in downlink control information (DCI), wherein a change success indication is received in an uplink control information (UCI) with the second RNTI, and wherein the change success indication indicates that the RNTI has been changed successfully. In some cases, the trigger to change RNTIs comprises the timer and wherein the timer is one of a preconfigured timer or a fixed time periodicity. In some examples, the timer is based on one of a system frame number (SFN), subframe number, or slot number. In some cases, the trigger to change RNTIs is transmitted using a MAC CE based message, and the computing device (or component thereof) may receive an acknowledgement of the trigger to change RNTIs using the second RNTI.

At block 1106, the computing device (or component thereof) may communicate with the wireless device based on the second RNTI.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 1000, process 1100, and/or other processes described herein may include a processor, microprocessor, micro-computer, or other component of a device that is configured to carry out the steps of the process 1000, process 1100, and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 1000, process 1100, and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1000 and process 1100 are illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 1000, process 1100, and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

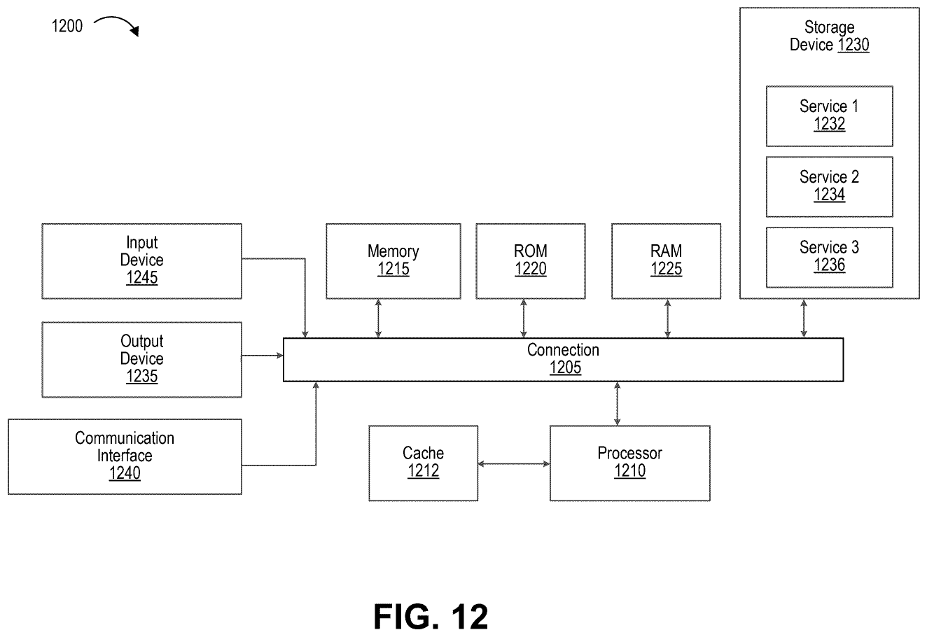

FIG. 12 is a diagram illustrating an example of a system for implementing certain aspects of the present technology. In particular, FIG. 12 illustrates an example of computing system 1200, which may be for example any computing device making up internal computing system, a remote computing system, a camera, or any component thereof in which the components of the system are in communication with each other using connection 1205. Connection 1205 may be a physical connection using a bus, or a direct connection into processor 1210, such as in a chipset architecture. Connection 1205 may also be a virtual connection, networked connection, or logical connection.

In some embodiments, computing system 1200 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1200 includes at least one processing unit (CPU or processor) 1210 and connection 1205 that communicatively couples various system components including system memory 1215, such as read-only memory (ROM) 1220 and random access memory (RAM) 1225 to processor 1210. Computing system 1200 may include a cache 1212 of high-speed memory connected directly with, in close proximity to, or integrated as part of processor 1210.

Processor 1210 may include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which may represent any number of input mechanisms, such as a microphone for speech, a touch-sensitive screen for gesture or graphical input, keyboard, mouse, motion input, speech, etc. Computing system 1200 may also include output device 1235, which may be one or more of a number of output mechanisms. In some instances, multimodal systems may enable a user to provide multiple types of input/output to communicate with computing system 1200.

Computing system 1200 may include communications interface 1240, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1230 may include software services, servers, services, etc., that when the code that defines such software is executed by the processor 1210, it causes the system to perform a function. In some embodiments, a hardware service that performs a particular function may include the software component stored in a computer-readable medium in connection with the necessary hardware components, such as processor 1210, connection 1205, output device 1235, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for wireless communications, comprising: at least one memory comprising instructions; and at least one processor coupled to the at least one memory and configured to: communicate with a network node based on first radio network temporary identifier (RNTI); determine to switch to a second RNTI; and communicate with the network node based on the second RNTI.

Aspect 2. The apparatus of Aspect 1, wherein the second RNTI is based on a list of multiple RNTIs.

Aspect 3. The apparatus of Aspect 2, wherein the at least one processor is configured to switch to the second RNTI based on a trigger to change RNTIs, wherein the trigger to change RNTIs triggers a change to a next RNTI on the list of multiple RNTIs.

Aspect 4. The apparatus of Aspect 1, wherein the at least one processor is configured to receive, from the network node after security activation of a registration procedure: an indication to dynamically determine the second RNTI, and an indication of a trigger to change to the second RNTI.

Aspect 5. The apparatus of Aspect 4, wherein the second RNTI is determined based on a message, and wherein the at least one processor is further configured to: receive the message from the network node; and determine the second RNTI based on the message received from the network node.

Aspect 6. The apparatus of Aspect 5, wherein the message received from the network node comprises one of a Radio Resource Control (RRC) message or a Medium Access Control Control Element (MAC CE) message.

Aspect 7. The apparatus of any of Aspects 5-6, wherein the message is received during one of an initial registration with the network node or intra-cell handover to the network node.

Aspect 8. The apparatus of any of Aspects 5-6, wherein the message is received after security establishment in an Access Stratum (AS) layer.

Aspect 9. The apparatus of any of Aspects 4-8, wherein the second RNTI is determined based on a preconfigured key and a key derivation formula.

Aspect 10. The apparatus of Aspect 9, wherein the preconfigured key is determined based on at least a key of the network node and a freshness parameter.

Aspect 11. The apparatus of Aspect 10, wherein the preconfigured key is further determined based on a physical cell identity.

Aspect 12. The apparatus of any of Aspects 9-11, wherein the second RNTI is further derived based on the first RNTI.

Aspect 13. The apparatus of any of Aspects 9-12, wherein the first RNTI and second RNTI are more than 16 bits long.

Aspect 14. The apparatus of any of Aspects 4-13, wherein the second RNTI is determined based on a PRACH procedure, and wherein the at least one processor is further configured to perform the PRACH procedure based on a PRACH inactivity timer, and wherein the indication to change RNTIs comprises receiving the second RNTI during the PRACH procedure.

Aspect 15. The apparatus of Aspect 14, wherein, to switch to the second RNTI, that at least one processor is further configured to transmit an indication of the second RNTI using one of an existing RRC connection or an uplink MAC CE.

Aspect 16. The apparatus of any of Aspects 4-15, wherein the at least one processor is configured to switch to the second RNTI based on a trigger to change RNTIs, wherein the trigger to change to the second RNTI is based on one of: a DCI-based message; a MAC CE based message; another RRC message; a timer; a number of packets transmitted with the first RNTI; and a number of transport blocks transmitted with the first RNTI.

Aspect 17. The apparatus of Aspect 16, wherein the trigger to change to the second RNTI is encoded in downlink control information (DCI), wherein a change success indication is transmitted in an uplink control information (UCI) with the second RNTI, and wherein the change success indication indicates, to the network node, that the RNTI has been changed successfully.

Aspect 18. The apparatus of Aspect 16, wherein the trigger to change to the second RNTI comprises the timer and wherein the timer is one of a preconfigured timer or a fixed time periodicity.

Aspect 19. The apparatus of Aspect 18, wherein the timer is based on one of a system frame number (SFN), subframe number, or slot number.

Aspect 20. The apparatus of Aspect 16, wherein the trigger to change to the second RNTI is received using a MAC CE based message, and wherein the switch to the second RNTI is performed when sending an acknowledgement of the trigger to change to the second RNTI.

Aspect 21. The apparatus of any of Aspects 4-20, wherein the at least one processor is configured to transmit capability information indicating how the apparatus supports receiving a trigger to change to the second RNTI.

Aspect 22. An apparatus for wireless communications, comprising: at least one memory comprising instructions; and at least one processor coupled to the at least one memory and configured to: communicate with a wireless device based on first radio network temporary identifier (RNTI); determine a second RNTI for the wireless device; and communicate with the wireless device based on the second RNTI.

Aspect 23. The apparatus of Aspect 22, wherein the second RNTI is based on a list of multiple RNTIs.

Aspect 24. The apparatus of Aspect 23, wherein the at least one processor is further configured to: generate a trigger to change RNTIs based on the determination to send the second RNTI, wherein the trigger to change RNTIs triggers a change to a next RNTI on the list of multiple RNTIs; transmit the trigger to change RNTIs to the wireless device; and switch to the second RNTI based on the transmitted trigger to change RNTIs.

Aspect 25. The apparatus of Aspect 22, wherein the at least one processor is further configured to: determine to dynamically determine the second RNTI; and transmit an indication to dynamically determine the second RNTI to the wireless device.

Aspect 26. The apparatus of Aspect 25, wherein a trigger to change RNTIs causes the wireless device to determine the second RNTI.

Aspect 27. The apparatus of Aspect 26, wherein the trigger to change RNTIs is transmitted using one of a Radio Resource Control (RRC) message or a Medium Access Control Control Element (MAC CE) message.

Aspect 28. The apparatus of any of Aspects 25-27, wherein the indication of how to determine the second RNTI is transmitted using one of a Radio Resource Control (RRC) message or a Medium Access Control Control Element (MAC CE) message.

Aspect 29. The apparatus of any of Aspects 25-28, wherein the indication of how to determine the second RNTI is transmitted during one of an initial registration with the apparatus or intra-cell handover to the apparatus.

Aspect 30. The apparatus of any of Aspects 25-29, wherein the indication of how to determine the second RNTI is transmitted after security establishment in an Access Stratum (AS) layer.

Aspect 31. The apparatus of any of Aspects 25-30, wherein, to dynamically determine the second RNTI, the at least one processor is further configured to determine the second RNTI based on a preconfigured key and a key derivation formula.

Aspect 32. The apparatus of Aspect 31, wherein the preconfigured key is determined based on at least a key of the apparatus and a freshness parameter.

Aspect 33. The apparatus of Aspect 32, wherein the preconfigured key is further determined based on a physical cell identity.

Aspect 34. The apparatus of any of Aspects 31-33, wherein the second RNTI is further derived based on the first RNTI.

Aspect 35. The apparatus of any of Aspects 31-34, wherein the first RNTI and second RNTI are more than 16 bits long.

Aspect 36. The apparatus of any of Aspects 25-35, wherein the second RNTI is determined based on a PRACH procedure, and wherein the at least one processor is further configured to perform the PRACH procedure based on a PRACH inactivity timer, and wherein the indication to change RNTIs comprises transmitting the second RNTI during the PRACH procedure.

Aspect 37. The apparatus of Aspect 36, wherein, to switch to the second RNTI, the at least one processor is further configured to receive an indication of the second RNTI using one of an existing RRC connection or an uplink MAC CE.

Aspect 38. The apparatus of any of Aspects 26-37, wherein the at least one processor is configured to transmit the trigger to change RNTIs using one of: a DCI-based message; a MAC CE based message; another RRC message; a timer; a number of packets transmitted with the first RNTI; and a number of transport blocks transmitted with the first RNTI.

Aspect 39. The apparatus of Aspect 38, wherein the trigger to change RNTIs is encoded in downlink control information (DCI), wherein a change success indication is received in an uplink control information (UCI) with the second RNTI, and wherein the change success indication indicates that the RNTI has been changed successfully.

Aspect 40. The apparatus of Aspect 38, wherein the trigger to change RNTIs comprises the timer and wherein the timer is one of a preconfigured timer or a fixed time periodicity.

Aspect 41. The apparatus of Aspect 40, wherein the timer is based on one of a system frame number (SFN), subframe number, or slot number.

Aspect 42. The apparatus of Aspect 38, wherein the trigger to change RNTIs is transmitted using a MAC CE based message, and wherein at least one processor is configured to receive an acknowledgement of the trigger to change RNTIs using the second RNTI.

Aspect 43. The apparatus of any of Aspects 26-42, wherein the at least one processor is configured to receive capability information indicating how the wireless device supports receiving the trigger to change RNTIs.

Aspect 44. A method for wireless communications, comprising: communicating with a network node based on first radio network temporary identifier (RNTI); determining to switch to a second RNTI; and communicating with the network node based on the second RNTI.

Aspect 45. The method of Aspect 44, wherein the second RNTI is based on a list of multiple RNTIs.

Aspect 46. The method of Aspect 45, further comprising switching to the second RNTI based on a trigger to change RNTIs, wherein the trigger to change RNTIs triggers a change to a next RNTI on the list of multiple RNTIs.

Aspect 47. The method of Aspect 44, further comprising receiving, from the network node after security activation of a registration procedure: an indication of how to determine the second RNTI, and an indication of a trigger to change to the second RNTI.

Aspect 48. The method of Aspect 47, wherein the second RNTI is determined based on a message, and further comprising: receiving the message from the network node; and determining the second RNTI based on the message received from the network node.

Aspect 49. The method of Aspect 48, wherein the message received from the network node comprises one of a Radio Resource Control (RRC) message or a Medium Access Control Control Element (MAC CE) message.

Aspect 50. The method of any of Aspects 48-49, wherein the message is received during one of an initial registration with the network node or intra-cell handover to the network node.

Aspect 51. The method of any of Aspects 48-49, wherein the message is received after security establishment in an Access Stratum (AS) layer.

Aspect 52. The method of any of Aspects 47-51, wherein the second RNTI is determined based on a preconfigured key and a key derivation formula.

Aspect 53. The method of Aspect 52, wherein the preconfigured key is determined based on at least a key of the network node and a freshness parameter.

Aspect 54. The method of Aspect 53, wherein the preconfigured key is further determined based on a physical cell identity.

Aspect 55. The method of any of Aspects 52-54, wherein the second RNTI is further derived based on the first RNTI.

Aspect 56. The method of any of Aspects 52-55, wherein the first RNTI and second RNTI are more than 16 bits long.

Aspect 57. The method of any of Aspects 47-56, wherein the second RNTI is determined based on a PRACH procedure, and further comprising performing the PRACH procedure based on a PRACH inactivity timer, and wherein the indication to change RNTIs comprises receiving the second RNTI during the PRACH procedure.

Aspect 58. The method of Aspect 57, wherein switching to the second RNTI comprising transmitting an indication of the second RNTI using one of an existing RRC connection or an uplink MAC CE.

Aspect 59. The method of any of Aspects 47-58, further comprising switching to the second RNTI based on a trigger to change RNTIs, wherein the trigger to change to the second RNTI is based on one of: a DCI-based message; a MAC CE based message; another RRC message; a timer; a number of packets transmitted with the first RNTI; and a number of transport blocks transmitted with the first RNTI.

Aspect 60. The method of Aspect 59, wherein the trigger to change to the second RNTI is encoded in downlink control information (DCI), wherein a change success indication is transmitted in an uplink control information (UCI) with the second RNTI, and wherein the change success indication indicates, to the network node, that the RNTI has been changed successfully.

Aspect 61. The method of Aspect 59, wherein the trigger to change to the second RNTI comprises the timer and wherein the timer is one of a preconfigured timer or a fixed time periodicity.

Aspect 62. The method of Aspect 61, wherein the timer is based on one of a system frame number (SFN), subframe number, or slot number.

Aspect 63. The method of Aspect 59, wherein the trigger to change to the second RNTI is received using a MAC CE based message, and wherein the switch to the second RNTI is performed when sending an acknowledgement of the trigger to change to the second RNTI.

Aspect 64. The method of any of Aspects 44-63, further comprising transmitting capability information indicating how a wireless device supports receiving a trigger to change to the second RNTI.

Aspect 65. A method for performing wireless communications according to any of Aspects 22-43.

Aspect 66. A non-transitory computer-readable medium having stored thereon instructions that, when executed by at least one processor, cause the at least one processor to perform operations according to any of Aspects 44-63.

Aspect 67. A non-transitory computer-readable medium having stored thereon instructions that, when executed by at least one processor, cause the at least one processor to perform operations according to any of Aspects 22-43.

Aspect 68. An apparatus, comprising one or more means for performing operations according to any of Aspects 44 to 63.

Aspect 69. An apparatus, comprising one or more means for performing operations according to any of Aspects 22 to 43.

What is claimed is:

1. An apparatus for wireless communications, comprising:
at least one memory comprising instructions; and
at least one processor coupled to the at least one memory and configured to:
communicate with a network node based on first radio network temporary identifier (RNTI);
determine to switch to a second RNTI; and
communicate with the network node based on the second RNTI.

2. The apparatus of claim 1, wherein the second RNTI is based on a list of multiple RNTIs.

3. The apparatus of claim 2, wherein the at least one processor is configured to switch to the second RNTI based on a trigger to change RNTIs, wherein the trigger to change RNTIs triggers a change to a next RNTI on the list of multiple RNTIs.

4. The apparatus of claim 1, wherein the at least one processor is configured to receive, from the network node after security activation of a registration procedure:
an indication to dynamically determine the second RNTI, and
an indication of a trigger to change to the second RNTI.

5. The apparatus of claim 4, wherein the second RNTI is determined based on a message, and wherein the at least one processor is further configured to:
receive the message from the network node; and
determine the second RNTI based on the message received from the network node.

6. The apparatus of claim 5, wherein the message received from the network node comprises one of a Radio Resource Control (RRC) message or a Medium Access Control Control Element (MAC CE) message.

7. The apparatus of claim 5, wherein the message is received during one of an initial registration with the network node or intra-cell handover to the network node.

8. The apparatus of claim 5, wherein the message is received after security establishment in an Access Stratum (AS) layer.

9. The apparatus of claim 4, wherein the second RNTI is determined based on a preconfigured key and a key derivation formula.

10. The apparatus of claim 9, wherein the preconfigured key is determined based on at least a key of the network node and a freshness parameter.

11. The apparatus of claim 10, wherein the preconfigured key is further determined based on a physical cell identity.

12. The apparatus of claim 9, wherein the second RNTI is further derived based on the first RNTI.

13. The apparatus of claim 9, wherein the first RNTI and second RNTI are more than 16 bits long.

14. The apparatus of claim 4, wherein the second RNTI is determined based on a PRACH procedure, and wherein the at least one processor is further configured to perform the PRACH procedure based on a PRACH inactivity timer, and wherein the indication to change RNTIs comprises receiving the second RNTI during the PRACH procedure.

15. The apparatus of claim 14, wherein, to switch to the second RNTI, that at least one processor is further configured to transmit an indication of the second RNTI using one of an existing RRC connection or an uplink MAC CE.

16. The apparatus of claim 4, wherein the at least one processor is configured to switch to the second RNTI based on a trigger to change RNTIs, wherein the trigger to change to the second RNTI is based on one of:
a DCI-based message;
a MAC CE based message;
another RRC message;
a timer;
a number of packets transmitted with the first RNTI; and
a number of transport blocks transmitted with the first RNTI.

17. The apparatus of claim 16, wherein the trigger to change to the second RNTI is encoded in downlink control information (DCI), wherein a change success indication is transmitted in an uplink control information (UCI) with the second RNTI, and wherein the change success indication indicates, to the network node, that the RNTI has been changed successfully.

18. The apparatus of claim 16, wherein the trigger to change to the second RNTI comprises the timer and wherein the timer is one of a preconfigured timer or a fixed time periodicity.

19. The apparatus of claim 18, wherein the timer is based on one of a system frame number (SFN), subframe number, or slot number.

20. An apparatus for wireless communications, comprising:
at least one memory comprising instructions; and
at least one processor coupled to the at least one memory and configured to:
communicate with a wireless device based on first radio network temporary identifier (RNTI);
determine a second RNTI for the wireless device; and
communicate with the wireless device based on the second RNTI.
